(19) United States
(12) Patent Application Publication
(10) Pub. No.: US 2021/0099060 A1
(43) Pub. Date: Apr. 1, 2021

(54) Combination motor generator with odd-numbered stator and magnet

(71) Applicant: Sten R. Gerfast, Mendta Heights, MN (US)

(72) Inventor: Sten R. Gerfast, Mendta Heights, MN (US)

(21) Appl. No.: 16/602,410

(22) Filed: Sep. 30, 2019

(51) Int. Cl. H02K 29/03; H02K 21/16

(52) U.S. Cl. CPC H02K 29/03; H02K 21/16

(57) ABSTRACT

This is a machine with unusual odd-numbered stator coils, and an automatic start position by a single stator-mounted magnet, allowing one (or 2) semi-conductors to start and run the alternate north and south rotor to run efficiently.

The rotor always stops in a start position by magnetic attraction.

The single magnet is also generating power during running.

The stator can be produced with 40% less material, and 40% less cost.

### BACKGROUND

All commercial motors have even-numbered stator poles.

Some three-phase motors have a combination of different stator poles, and different rotor poles, such as 6-12 or 4-6.

Some two-phase motors, or one phase motor, as sometime designated by Engineers, have equal number of stator poles and magnet poles.

But commercial machines, produced in large quantities always have even-numbered stator poles.

The present invention has an un-usual and un-common odd-numbered stator poles in the motor

The odd-numbered motor stator is combined, in the same structure, with a generator, both rotating on a common shaft

### DESCRIPTION OF THE PRESENT INVENTION

This is a combination motor-generator, that could be written up as:

a normal powered stator pulse
casing rotor motion,
followed by a non-powered magnet repulsion step,
wherein the repulsion also generates power
out of phase with the normal power pulses.

This is a combination motor-generator, which also could be described as: a Gerfast motor-generator wherein rotor rotation is accomplished,

as a first step, by a power pulse into the stator, rotor motion, and secondly, by a stator magnet repelling a rotor magnet, thereby taking a second step, which is non-powered, and continuing these two sequences.

It could also be described as:

A combination motor-generator comprising:

a motor stator with odd-numbered wound-coil poles,
Further description of the present invention.

This is a combination motor-generator, that could be described as:

This unique motor generator combination has an odd-numbered stator with windings, and an additional permanent magnet pole, in a round shaped stator lamination. Lamination alternative such as Gerfast's “Linear series of open jaw coil winding slots”, application Ser. No. 15/999,941 is an excellent lamination. The rotor in this motorgenerator is a common deign with alternate north and south magnets used in many brushless motors today. The permanent magnet pole, such as a south pole, automatically attracts, and lines up with a north pole on the rotor, whenever the power is shut off. This condition provides for an automatic “start position” at all the occasions when the motor is turned off. This automatic start position allows for a SINGLE semiconductor to send a power drive pulse into the odd-numbered stator coils to make the rotor take one step, and repeat, to drive this unique motor generator continuously. The rotor is journaled to run in close relation to the stator. The timing of the drive pulse is done with a sensor. This unique design could be described as Gerfast's odd-numbered stator for a motor and generator combination, having excellent efficiency and having almost noiseless operation.

The very quiet operation and low power needed for running, is accomplished by 1. The short timing of the power pulse followed by 2. A non-powered motion caused by magnetic attraction by a south pole attracted to a north pole. [This function is also a generator function which can be observed on an oscilloscope during coast down of the rotor]. By the very correct timing of these two operations, augmented by the rotor inertia, and possibly also, by a fan blade inertia, a very smooth operation is accomplished. As an example, this motor generator running with a 5 bladed 10 inch [254 mm] diameter fan blade, at 500 RPM gave an average noise level, measured (Db) to be almost the same as the noise level of a very quiet room.

The short timing pulse created by the single semiconductor and the timing, as with a Hall sensor, can be manufactured by a number of manufacturers, used to doing signal designs.

Individual components are not listed separately, but are common in the industry, and are still becoming part of this invention, as “alternate designs”.

The angular position of this sensor, away from the zero angle between stator poles determines the rotation of the rotor.

As an example, plus 7 degrees equals one direction, and minus 7 degrees equals the other, with other fine adjustments. Most brushless motors, on the market today, has a non-uniform rotation that is generally named “cogging”. This motor generator with the drive pulse, plus a generator pulse, is almost void of any cogging. Further background.

All commercial motors have even-numbered stator poles.

Some three-phase motors have a combination of different stator poles, and different rotor poles, such as 6-12 or 4-6.

Some one-phase motors, have equal number of stator poles and magnet poles. Any commercial machines, produced in large quantities always have even-numbered stator poles.

The present invention has an un-usual and un-common odd-numbered stator poles in the motor. The odd-numbered motor stator is combined, in the same structure, with a permanent magnet pole which does two functions: first, as an “always return to start position” device, and secondarily, as a generating action device when the rotor is running. The generating action, by phase angle, counteracts and minimizes the incoming power pulses, thereby increasing the efficiency of the motor/generator.

### FURTHER BACKGROUND

All commercial motors have even-numbered stator poles. Some three-phase motors have a combination of different stator poles, and different rotor poles, such as 6-12 or 4-6. Some two-phase motors, or one phase motor, as sometime designated by Engineers, have equal number of stator poles and magnet poles.

But commercial machines, produced in large quantities always have even-numbered stator poles.

The present invention has an un-usual and un-common odd-numbered stator poles in the motor

The odd-numbered motor stator is combined, in the same structure, with a permanent magnet pole which does two functions: first, as an “always return to start position” device, and secondarily, as a generating action device when the rotor is running. The generating action, by phase angle, counteracts and minimizes the incoming power pulses, thereby increasing the efficiency of the motor/generator.

The start position is shown in FIG. 8. The power drive pulse into the multitude of odd-numbered stator poles is creating a south pole in front of the permanent magnetic south pole, thereby repulsing the rotor to move into a position as shown in FIG. 9. At that time a turn-off of the power pulse occurs, and the next north pole swing into position in front of the magnetic south pole by magnetic attraction. This attraction is non-powered, and moves into next “start position”. But the non-powered secondary movement of attraction, when the rotor swings into place, is a generator action, creating generated power into the stator. Therefor the power pulse and the generated power equals out. at zero output power. This balanced out short power pulse followed by a nonpowered magnetic movement makes for a smooth rotor rotation, without any cogging. Similarly mowing the rotor shaft one half turn by hand, it would be hard turning, until center, then it would automatically go the next half turn. But of course, in order to have power shaft output, the short power pulse has to be greater than the generator output.

The timing of the power pulse is generated by a rotor position sensor such as a magnetic Hall sensor or optical sensor.

### BRIEF DESCRIPTION OF THE DRAWINGS

FIG. 1 is an overview of a motor generator that can have any number of poles (in this case showing a six-pole motor) having an odd-numbered stator, (in this case with 5 wound stator poles) having a permanent magnet placed in the sixth position, with a rotor with alternating polarity, journaled in the center of the stator, shown in the start position.

2. Is an overview of a motor generator shown how a drive pulse into the multitude of odd-numbered stator poles is creating a south pole in front of the permanent magnetic south pole, thereby repulsing the rotor to move into a position as shown in FIG. 2. At that time a turn-off of the power pulse occurs, and the next north pole swing into position in front of the magnetic south pole by attraction.

FIG. 3 is a view of how the FIG. 1 can be produced, showing a strip in the process of being circle formed, partially wound, and having a high energy south pole magnet, with lamination backing, that are attached in the fifth position.

FIG. 4 is showing how a single semiconductor drive circuit is generating pulses at the correct time.

FIG. 3 This is an illustration of an oscilloscope trace of the signal 200 when this motor/generator is driven to rotate with an external device In other words, the rotor magnets together with the stator magnet, is generating current pulses in the stator. Another unique un-expected result is that when running normally on the drive circuit, with only a fly wheel as a load, the generated signal 200 is showing a very low watt-meter reading. This type of generation, when running with a load, such as a fan blade, show this unique motor/generator to have substantially lower power consumption, and therefore higher efficiency. Another unique aspect of this motor/generator is that a normal drive circuit have 6 or 4 power devises, but this circuit has only One. which makes a much less expensive total package. The higher efficiency is saving kilo-watts-hours, over a year's time.

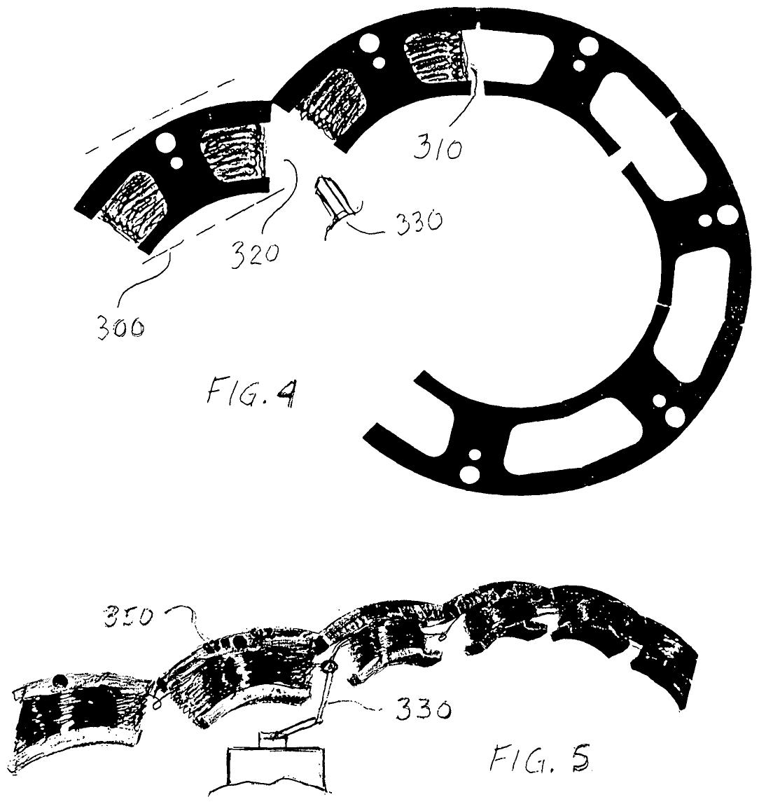

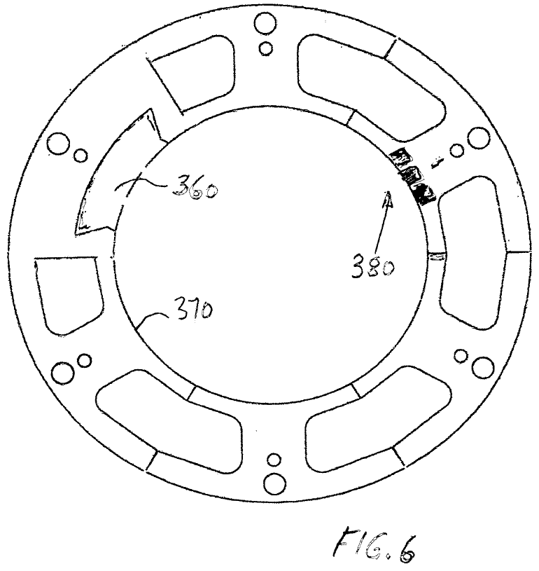

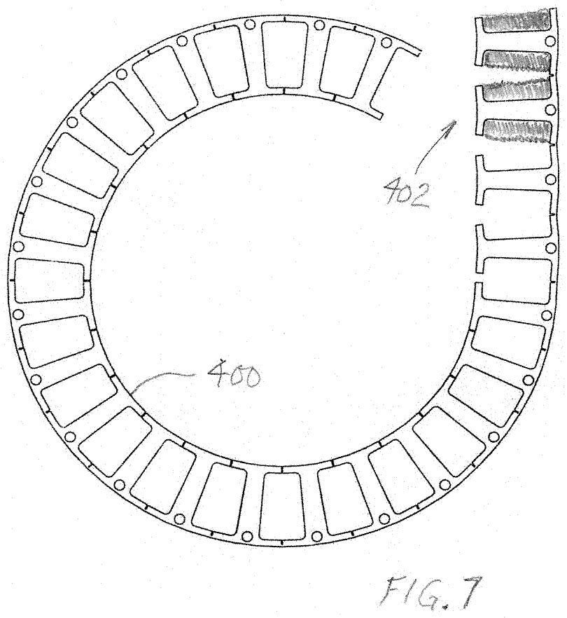

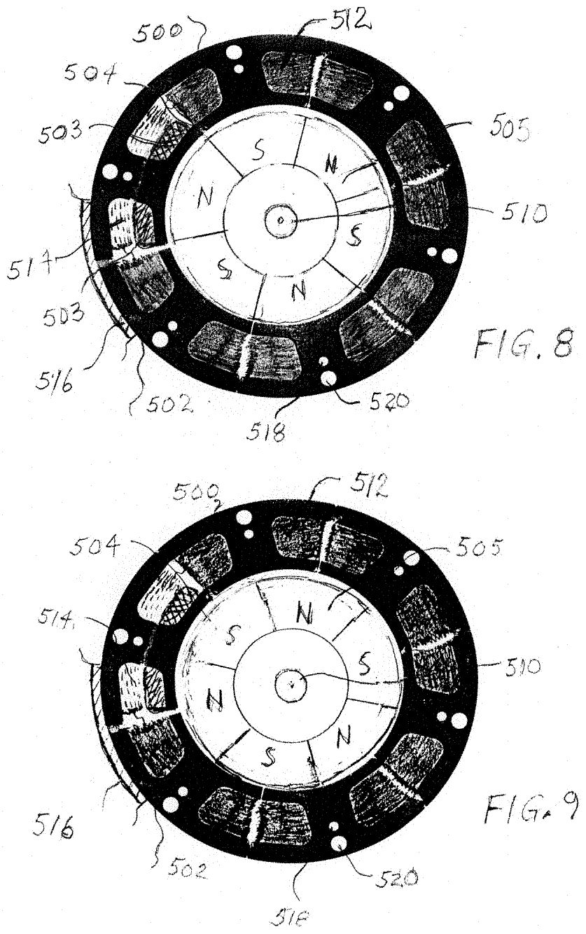

FIG. 4 is a view of how the stator can be made as a strip with 40% less material used, compared to a “round lamination”. The savings of material is shown at 300. About 95% copper-fill 310 are achieved at the first two poles, shown as “open jaw” in 320 position, which makes it possible to “bobbin wind” and “level wind” with a large needle 330, before circle-forming.

FIG. 5 Is showing a photograph of a wound strip 350, before forming, but totally wound alternate south-north. It is wound with about 95% copper-fill.

FIG. 6 Is showing a more economical assembly of a magnet 360 in a circle-formed stator 370. Also shown is sensors, either magnetic Hall sensors, or optical sensors 380, shown minus 7 Degrees, Zero degrees or Plus 7 degrees from center-line.

FIG. 7 is showing a 24 pole stator 400 with a partially formed “open jaw” section 402, that can be wound with 95% fill. The start position is shown in FIG. 8. The power drive pulse into the multitude of odd-numbered stator poles is creating a south pole in front of the permanent magnetic south pole, thereby repulsing the rotor to move into a position as shown in FIG. 9 At that time a turn-off of the power pulse occurs, and the next north pole swing into position in front of the magnetic south pole by attraction. The repulsion requires a short power pule to move into the position shown in FIG. 9, but the non-powered secondary movement of attraction, when the rotor swing into place, is a generator action, creating generated power into the stator. Therefor the power pulse and the generated power equals out. at zero output power. Similarly mowing the rotor shaft one half turn by hand, it would be hard turning, until center, then it would automatically go the next half turn. But of course, in order to have power shaft output, the short power pulse has to be greater than the generator output.

The timing of the power pulse is generated by a rotor position sensor such as a magnetic or optical sensor. The angular position of this sensor, away from the zero angle between stator poles determines the rotation of the rotor. As an example plus 7 degrees equals one direction, and minus 7 degrees equals the other, with other fine adjustments.

### DETAILED DESCRIPTION OF THE DRAWINGS

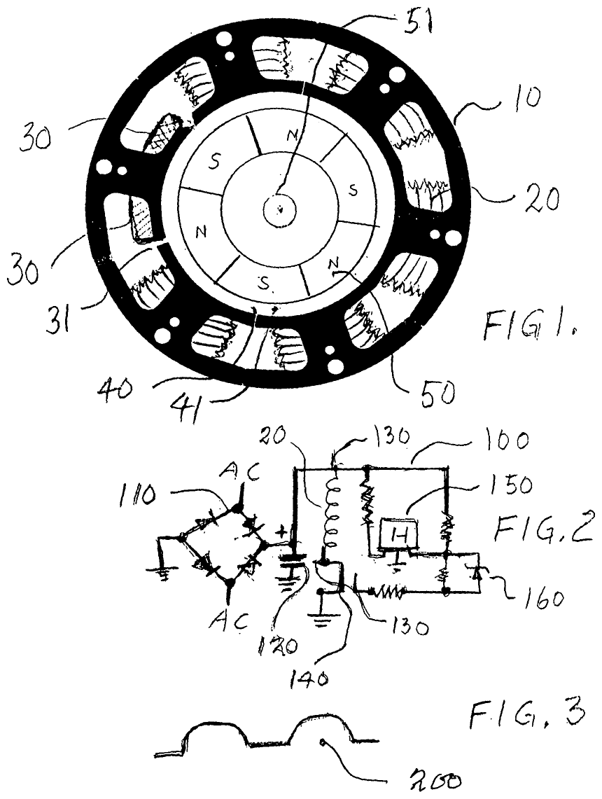

FIG. 1 is showing the odd-numbered stator 10 wound with 5 coils, (in this case with 5 windings 20, on the 5 wound stator poles) and having a permanent magnet 30 placed in the sixth position. The magnet 30 is having the same inside radius as the 5 poles. The magnet 30 may have an angular offset 31, or be centered. The permanent magnet 30 can be of ceramic material, and so can the rotor magnets. Or, one or both can have a higher or lower magnet coercivity, or altered thickness on both magnets. For illustration, the air-gap 41 between rotor 50 and stator 10 is shown over-sized, the real airgap is a normal 0.015″ (0.35 mm). A journaled 51 rotor 50 with alternate polarity magnets 40 are centered in the stator 10.

The rotor 50, with its rotor magnet 40 is shown ready to repel a stator magnet 30. and thereby assume a start position.

FIG. 2 is showing one possible circuit 100 for pulse generation. This circuit is AC, alternate polarity, operated with a 4-diode bridge 110.

located next to the rotor 50, providing magnetic signals from the magnets on the rotating 50, thereby synchronizing the pulses to the power devise 140.

Necessary resistors are shown together with a Zener diode 160. This is only one possible circuit, many modifications can be made without altering the scope of this invention.

FIG. 3 This is an illustration of an oscilloscope trace of the signal 200 when this motor/generator is driven to rotate with an external device In other words, the rotor magnets together with the stator magnet, is generating current pulses in the stator. Another unique un-expected result is that when running normally on the drive circuit, with only a fly-wheel as a load,

the generated signal 200 is showing on a watt-meter as negative watts. This type of generation, when running with a load, such as a fan blade, show this unique motor/generator to have substantially lower power consumption, and therefore higher efficiency.

FIG. 4 Is a view of how the stator in FIG. 1 can be produced as a strip (less material used, better copper-fill) showing a strip in the process of being “circle formed”, It is partially wound with about 95% copper fill.

FIG. 5 is a photograph of similar strip form, wound with about 95% copper fill on the first two poles. It is wound with alternate polarity (north south) windings. FIG. 6 is an alternate assembly method of the magnet in the stator, which is also more economical. The magnet is simply dropped into a slot and is held b_{y} magnetic force.

FIG. 7 is showing a 24 pole stator with two coils wound with about 95%. It also shows that the present invention can be any size and any number of poles.

FIG. 8 is a combined showing of a stator generator with a rotor with alternate polarity magnets, journaled in the stator, with a shaft. The spacing between the rotor and the stator (normally 0.20″, ½ mm) is larger than normal, for clarity. The rotor is shown in start position.

FIG. 9 is the same FIG. 8 motor generator shown in the first powered position, by pulse from the driving circuit, to move the rotor correctly.

An assembly of a motor generator is shown in the start position, and is shown in FIG. 8. After a power turn-off this is the position that the rotor always returns to. Thereafter, a power drive pulse into the start of winding 500 and finish of winding 502 powers the multitude of odd-numbered [numbers not shown] stators 5 poles. This pulse is creating a south pole in front of the permanent magnetic south pole 503, thereby repulsing the rotor 505 to move into a half position as shown in FIG. 9. At that time a turn-off of the power pulse occurs, and the next north pole swings into position in front of the magnetic south pole by magnetic attraction. This attraction is non-powered, and moves into a next “start position”. But the non-powered secondary movement of attraction, when the rotor swings into place, is a generator action, creating generated power into the stator. Therefor the power pulse and the generated power equals out. at zero output power. This balanced out, short power pulse followed by a nonpowered magnetic movement makes for a smooth rotor rotation, without any cogging. Similarly mowing the rotor shaft one half turn by hand, it would be hard turning, until center, then it would automatically go the next half turn.

But of course, in order to have power shaft output, the short power pulse has to be greater than the generator output.

The timing of the power pulse is generated by a rotor position sensor such as a magnetic Hall sensor or optical sensor. Not shown.

And all the 5 windings are shown to be about 95% at 512.

The pole 503 can have an additional winding 514 shown in dash lines. A outside steel rolled iron case, which enhances the magnetics is shown at 516.

Circular holes for rivets 518 are holding the laminations in these figures. The rotor has a centrally located shaft 510.

Both FIG. 8 and FIG. 9 have the same reference numbers. The number of laminations which are combined together, is what is called a stack, which can be any length.

Circular holes 520 are for mounting screws.

Comparison of brushless motor cost and drive design.

| Designtype | circuit | transistor | magnets | sensors | lamin.cost | size | cost |
|---|---|---|---|---|---|---|---|
| 3 phase | 100% | 6 | 8 | 3 | 100% | 100% | 100% |
| 2 phase I | 80% | 4 | 6 | 1 | 100% | 70% | 60% |
| Gerfast II | 30% | 4 | 6 | 1 | 60% | 70% | 45% |
| Gerfast Motor | 15% | 1 | 5 | 1 | 60% | 45% | 20% |
| generator III | | | | | | | |

The comparison is based on a very common design of a “Brushless” motor, produced by many manufacturers today. It is assigned a 100% number. The 2 phase design is based on Gerfast's U.S. Pat. No. 6,850,019 “A single coil Brushless motor”, and Gerfast's U.S. Pat. No. 6,940,238, “A Brushless motor with voltage boost”. These two motors are in production in the United States. About 2 million motors have been made, which becomes a good basis for a comparison.

The Gerfast III design is a present patent application Ser. No. 15/999,941. which is a unique type a laminations called “open jaw” laminations, manufactured in a strip form. The open jaw allows for a magnet wire winding, of about 95% “copper fill”, where normal winding of laminations is a maximum of about 56%. In addition the “strip type” saves about 60% of lamination steel or specialty material.

1. A combination motor generator comprising:
a motor stator with odd-numbered wound coil poles,
a permanent magnets south pole attached on an un-wound pole,
a rotor with alternate north-south magnets, the rotor journaled to rotate in the stator, wherein a rotors north pole always stops by
the permanent magnet's south pole, creating a start position, wherein power pulses, by a single semiconductor into
the odd-numbered coils, makes the motor generator start and run smoothly, without cogging,

2. A combination motor generator comprising:
a motor stator with odd-numbered wound coil poles,
a permanent magnets south pole attached on an un-wound pole,
a rotor with alternate north-south magnets, the rotor journaled to rotate in the stator, a rotor north pole always stops by attraction next to the permanent magnet's south pole, creating an start position,
an electrical pulse into the odd numbered coils, changes attract mode to repulse mode, wherein the rotor moves one half coil length,
and then again moves into attract mode, and continues to move,
as long as pulses are supplied, allowing a single semiconductor to power the wound coils, thereby starting and running the motor smoothly, without cogging,

3. A combination motor generator according to claim 1,
using a four-pole structure, with the unwound pole having a south magnet, where one of the rotors north poles will be attracted into a start position,
allowing a single semiconductor to power 3 wound coils,
thereby overpowering the magnetic attraction between the south and north pole in their start position,
first, the rotor moves one half coil length, and secondary, magnetic attraction again assumes a start position,
and repeat, to run the motor, with this action called 3-1.

4. A combination motor generator according to claim 1,
using a six-pole structure, with the unwound coil having a south magnet, and one of the rotors north poles will be attracted into a start position,
allowing a single semiconductor to power 5 wound coils,
thereby overpowering the magnetic attraction between the south and north pole in their start position,
first, the rotor moves one half coil length, and secondary, magnetic attraction again assumes a start position,
and repeat, to run the motor, with this action called 5-1 and consecutive higher pole structures, like eight poles, called 7-1,
twelve poles, called 11-1 and so on.

5. A combination motor generator according to claim 4
wherein two magnets are assembled on unwound coils in the stator, with this action called 2-2, 4-2, 6-2, 10-2,
and if three magnets are assembled on the stator,
it is called 3-3, 5-3, 9-3, and consecutively so,
in higher pole structures.

6. A combination motor generator according to claim 4
wherein the single coil having south magnets,
the wound coil presiding it, and the wound coil following it,
by magnetic inter action, both coils become north poles,
and the trio of coils are becoming generating coils,
as long as the rotor with alternating magnets is rotating,
with the generating phase relationship being out of phase with the semiconductor driving phase,
thereby minimizing the input to the semiconductor;
producing a machine with lower watt input under the same load conditions.

7. A combination motor generator comprising:
a motor stator with odd-numbered wound coils,
and an additional S pole permanent magnet,
wherein the coils are made as a string of laminations poles,
wound, and formed into a circle,
a rotor with N-S magnets journaled inside the circle,
the rotors N pole always stopping in front a of the S pole,
and when power pulses connected to the wound coils,
by a single semi-conductor, the rotor first takes a half step,
and continues to run smoothly without cogging.

8. A combination motor generator according to claim 7
wherein rotor rotation is accomplished after stopping,
firstly, by a pulse into wound coils, secondly by a stator magnet repelling a rotor magnet, which is non-powered, and continuing
these two sequences to run smoothly without cogging.

9. A string of coils formed into a stator circle according to claim 7
wherein rotor rotation is accomplished firstly, by a pulse into the wound coils,
wherein the rotor is taking a half-step, and secondly, another half step by a stator magnet repelling a rotor magnet, which is non-powered,
and wherein the stator magnet repelling motion also generates power into the stator, out if phase with the power pulses making a very un-usual, very efficient, motor generator.

10. A combination motor-generator according to claim 1
wherein the motor-generator has a powered phase and a non-powered phase, interacting to get better efficiency.

11. A combination motor-generator according to claim 1
wherein the stator magnet is replaced with either 1 or 2 stator magnets in a four-pole machine, and the stator magnet is replaced with either 1, 2 or 3 stator magnets in a six-pole machine,
and similarly, in machines with fewer or greater number of poles.

12. A combination motor-generator according to claim 1
wherein the rotor is driven by an external device,
and the machine is used as a generator-motor,
and wherein the power pulse device is eliminated,
and the coils from the odd-numbered wound-coil poles are connected together to give generator output,
shown in the figures.

13. A combination motor-generator according to claim 1
wherein when it is running with a load, this unique motor/generator designated Gerfast unique motor/generator, has substantially lower power consumption, and therefore higher efficiency.

14. A combination motor-generator according to claim 1
wherein when it is running with a load, this unique motor/generator designated as Gerfast unique motor-generator, also generates inductive pulses our of phase with the drive pulses.

15. A combination motor-generator according to claim 1
wherein when it is running with a load, this unique motor/generator designated as Gerfast unique motor-generator, also generates inductive pulses our of phase with the drive pulses,
but in sync with the power pulses.

16. A combination motor-generator according to claim 14
wherein the out of phase pulses subtracts from the drive pulses, to also subtract from input power, therefore has better efficiency.

17. A combination motor-generator according to claim 1
wherein the magnetic sensor is providing magnetic signals from the magnets on the rotor, thereby synchronizing the pulses.

18. A combination motor-generator according to claim 1
wherein the coils have additional connections affecting the running and synchronization of pulses.

19. A motor generator according to claim 2
wherein the change from repulse mode to attract mode is equally balanced, and is balanced in the power draw from the circuit,
and is therefore a smooth running, efficient and almost noiseless machine.

20. A motor generator according to claim 2, where it is designed as an efficient electric car motor, but still has a 40% saving of lamination material.
